(19) United States
(12) Patent Application Publication
(10) Pub. No.: US 2012/0134721 A1
(43) Pub. Date: May 31, 2012

(54) DEVELOPMENT DEVICE, PROCESS CARTRIDGE AND IMAGE FORMING APPARATUS

(75) Inventors: Hiroya ABE, Yokohama-shi (JP); Rei Suzuki, Zana-shi (JP); Masashi Nakayama, Isehara-shi (JP)

(73) Assignee: RICOH COMPANY, LTD., Tokyo (JP)

(21) Appl. No.: 13/305,982

(22) Filed: Nov. 29, 2011

(30) Foreign Application Priority Data
Nov. 30, 2010 (JP) 2010-267404

(51) Int. Cl. G03G 15/08

(52) U.S. Cl. 399/265

(57) ABSTRACT

A development device includes a toner carrier having a plurality of long outside electrodes provided at intervals in a first predetermined depth position from a toner carrying surface, and a longitudinal direction of each outside electrode crossing a toner carrying direction, an inside electrode provided at least in a portion between the long outside electrodes in a second predetermined depth position deeper than the first predetermined depth, and an insulation layer between a layer having the outside electrodes and a layer having the inside electrode; and a voltage applier configured to apply a voltage which hops toners on the toner carrying surface to the inside electrode and the outside electrodes.

### PRIORITY CLAIM

The present application is based on and claims priority from Japanese Patent Application No. 2010-267404, filed on Nov. 30, 2010 the disclosure of which is hereby incorporated by reference in its entirety.

### BACKGROUND

1. Technical Field

The present invention relates to a development device including a developer carrier which delivers developer to a development area by the surface movement of an outer circumferential surface carrying the developer, a process cartridge and an image forming apparatus including the development device.

2. Description of the Related Art

A development device including a developer carrier having a plurality of electrodes to which different voltages are applied is known.

For example, a development device, which develops a latent image on a latent image carrier by supplying developer without bringing the developer on a developer carrier into contact with the latent image carrier such as a photoreceptor, is known. As one example of this development device, a method of supplying toners onto a latent image carrier by clouding one-component developer (toner) on a developer carrier is known.

The developer carrier for use in this method includes plural types of electrodes which are arranged on the outer circumferential surface at predetermined pitches, and a protection layer which covers the outer circumferential surface of the plural types of electrodes. Different time variable voltages are applied to the plural types of electrodes to form a time variable electric field among the adjacent plural types of electrodes, so that the toners on the developer carrier can be hopped among the adjacent plural types of electrodes by the electric fields (this phenomenon (hopping of toners) is hereinafter referred to as flare). The toners are thereby clouded in a space near the outer circumferential surface of the developer carrier.

In order to generate flare without transferring toners onto the outer circumferential surface of the developer carrier in this development device, the relationship between a force F1 that the toners receive from the electric field for the flare to be formed among the adjacent plural types of electrodes and an adhesion F2 between the toners and the outer circumferential surface of the developer carrier becomes important. If F2 is larger than F1, the toners can not be released from the adhesion to the outer circumferential surface of the developer carrier, so resulting in that no flare is being generated. On the other hand, if the F1 is larger than F2, the flare is generated. In this case, the larger the difference between F1 and F2, the more stable the flare. This difference can be increased by increasing F1. In order to increase F1, it becomes necessary to increase the size of the electric field for the flare which is formed on the outer circumferential surface of the developer carrier.

Patent Document 1 (Japanese Patent Application Publication No. 2007-133388) discloses a development device including a developer carrier roller having two types of electrodes, which are concentrically arranged, for forming an electric field for the flare. The two types of comb-shaped electrodes are provided on the outer circumferential surface of the developer carrier such that the comb-shaped portion of one electrode is fitted to the comb-shaped portion of the other electrode. By applying the above-described voltage to the electrodes, the toners can be hopped among the comb-shaped portions to generate flare.

Patent Document 2 (Japanese Patent Application Publication No. 2008-116599) discloses a developer carrier roller including three types of electrodes for forming an electric field to provide flare. In this developer carrier, two types of electrodes are concentrically arranged and another electrode is arranged on a side which is closer to the outer circumferential surface than the two concentrically arranged electrodes. In the development device using this developer carrier, by applying a three-phase voltage, each of which has a different phase applied to different electrodes, the toners can be hopped among the various electrodes to generate flare.

As another example of a development device including a developer carrier having a plurality of electrodes to which different voltages are applied, for example, the development device described in Patent Document 3 (Japanese Patent Application Publication No. H1-31611) is known. In this development device, two types of electrodes for forming an alternating electric field (electric field for charging) which charges the toners by vibrating the toners on the developer carrier are provided. These two types of electrodes are insulated by air both internally and externally. However, a process which covers between the electrodes with an insulation material is not disclosed.

Referring to Patent Document 4 (Japanese Patent Application Publication No. 2010-164932), in a developer carrier including plural types of electrode members to which different voltages are applied, plural types of electrode members are disposed in positions different from one another in the normal direction of the outer circumferential surface, and an insulation layer is provided between the electrode members. In the development device using this developer carrier, voltages each having a different phase are applied to the various types of electrodes, so that the toners can be hopped among the various electrodes to generate flare.

In order to generate the electric field for the flare and the electric field for the charging larger with the configuration including the plural types of the electrodes concentrically arranged on the roller as described in Patent Documents 1-3, it becomes necessary to effectively prevent leakage among the electrodes. In the conventional configuration, if a resin material with insulation properties or air is provided among the electrodes, the insulation property among the electrodes can be sufficiently ensured when applying a relatively small voltage. However, if a relatively large voltage is applied to make the electric field larger, it becomes difficult to sufficiently ensure an insulation property among the electrodes for the following reason.

Patent Document 1 describes that metallic plating is performed on the surface of the resin roller having on the surface thereof a comb-shaped groove, and then, the two types of comb-shaped electrodes are formed by grinding the surface of the roller. In addition to this method, as a method of forming two types of comb-shaped electrodes concentrically arranged on the roller, a method of forming a roller having a metal-plated surface into a comb shape by etching, and a method of forming a comb-shaped electrode by injecting conductive ink with an ink jet method and the like are known. In any method, the insulation property between the electrodes is obtained by coating the roller surface having the comb-shaped electrodes with the insulation material provided between the two types of electrodes. In this case, an interface between the resin surface of the roller and the coated insulation material is formed between the two types of electrodes. For this reason, the leakage is more likely to occur through this interface, and it becomes difficult to sufficiently ensure the insulation property between the electrodes if a relatively large voltage is applied.

Moreover, Patent Document 2 describes that the two types of electrodes are concentrically arranged. The method of forming these two types of electrodes is similar to the method described in Patent Document 1, so that leakage through the interface is also more likely to occur. It is also difficult to sufficiently ensure the insulation property of the two types of electrodes for a similar reason to the configuration described in Patent Document 1. In addition, since the insulation layer is provided between the two types of electrodes and the remaining one type of electrode, leakage through the interface between these electrodes does not occur. However, an appropriate electric field for the flare can not be formed if leakage occurs between the two types of electrodes even if leakage does not occur between the two types of electrodes and the remaining one type of electrode.

Furthermore, in the configuration described in Patent Document 3, the process which covers between the two types of electrodes by the insulation material is not performed, so that leakage occurs through the toners when the toners are supplied between the electrodes.

In addition, if a developer carrier including plural types of electrode members to which different voltages are applied is used, the above-described leakage problem may be generated regardless of the purpose of the applied voltage.

Further, in the configuration described in Patent Document 4, the interface between the electrodes in Patent Documents 1, 2 is lost by providing the insulation layer between the inside electrode and the outside electrode, and the toners do not have contact with the electrode by coating the outside of the outside electrode with the insulation member, so that leakage does not occur in the early stage.

In this case, if the electrode material is made of silver, copper, lead, tin or an alloy of these, a part of the electrode material is ionized with long-term use, moves in the insulation layer and is reduced (metalized) on the other electrode, so that the leakage occurs between the electrodes.

The above phenomenon is generally called ion migration which is an electrochemical migration phenomenon of metal. This ion migration generally occurs in a material of an electrode made of silver, copper, solder (tin, lead) or the like, and the ion migration occurs most commonly in silver and copper.

Hereinafter, this ion migration will be described. If voltage is applied to foil, plating or paste metal in a high humidity environment, the metal stain-like or dendritically migrates on the surface of an insulation member by electrolyzation, and grows up. As a result, the insulation resistance value is lowered between the electrodes, and leakage occasionally occurs. In the typical ion migration, the stain-like growth occurs from a positive electrode side and the dendrite growth occurs from a negative electrode side. However, since the ion migration is effected by the type of insulation member, the environmental condition and the like, the metallic ion melted from the positive electrode side may be reduced, and may be precipitated as metal, and the precipitation from the negative electrode side may stain without being dendritic. Moreover, since silver reacts readily with sulfur (S) or chlorine (Cl), these elements are often simultaneously detected when analyzing with XMA (X-ray micro analyzer) or the like.

Next, the generation mechanism of the ion migration in silver will be described.

If water is adhered between silver electrodes to which DC voltage is applied, the chemical reaction according to the following expression (1) occurs in the positive electrode.

[Expression 1]

Ag+OH→AgOH+e- (1)

Since the silver hydroxide (AgOH) generated herein is very unstable, it is decomposed according to the following expression (2).

[Expression 2]

2AgOH→Ag2O+H2O (2)

The generated colloid silver oxide (Ag₂O) reacts according to the following expression (3).

[Expression 3]

Ag2O+H2O [symbol] 2AgOH [symbol] 2Ag+2OH— (3)

As described above, if the generated colloid Ag₂O and the silver ion gradually move (specially, the silver ion is pulled by an electric field), and reach the negative electrode, they are reduced according to the following expression (4) to be metallic silver.

[Expression 4]

Ag++e-→Ag (4)

This precipitated silver becomes in general a white dendrite. The strength of the electric field on the leading end increases with the growth, so that the growth progresses at an accelerated rate once the growth begins.

Next, the acceleration factor and the countermeasure of the ion migration will be described.

(a) Electric potential difference and electrode interval: Since the ion migration is an electrochemical reaction, it is a problem only when applying DC. The time until leakage occurs between the electrodes is substantially inverse proportional to the electric potential difference and is substantially proportional to the interval.

Because the electric potential difference between the electrodes in Patent Document 4 is 0V (AC and DC having the same potential as AC are superimposed to each electrode), the generation factor by the electric potential difference is considered to be small, but because the electrode interval is very narrow about 20 μm to 40 μm, it is considered that leakage is more likely to occur due to the electrode interval.

(b) Temperature: The effect of the temperature is small compared to humidity, but the chemical reaction speed is increased with temperature, resulting in the progression of the ion migration.

(c) Humidity (specifically, condensation): The humidity significantly has effect on the ion migration. In general, if the relative humidity is 50% or below, the ion migration does not progress, and if the relative humidity is 70% or above, the ion migration rapidly progresses. The leakage between the electrodes in the above Patent Document 4 is more likely to occur in a high temperature and high humidity environment.

(d) Insulator type: The insulator type has a significant effect on the ion migration similar to humidity. The ion migration remarkably occurs in a phenol resin-laminated plate having a large hydroscopic property, nylon or the like, but it hardly occurs in a glass epoxy base plate having a small hydroscopic property.

The material of the insulation layer in Patent Document 4 is limited, so that the countermeasure provided by the material is limited.

(e) Dust level and water quality: Because dust includes in itself a water-soluble component or dust works as a water-holding body, the ion migration progresses. In addition, if the electrolyte concentration is increased, the water quality is improved.

### SUMMARY

The present invention has been made in view of the above circumstances. An object of the present invention is to provide a development device including a toner carrier which delivers toners to a development area of a latent image carrier by hopping the toners on the outer circumferential surface, a developer carrier without generating leakage through the toners and the interface between electrodes provided in the toner carrier and without generating leakage by ion migration between electrode members in the long term, a development device, a process cartridge, and an image forming apparatus using the developer carrier.

In order to achieve the above object, one embodiment of the present invention provides a development device, including: a toner carrier, including: a plurality of long outside electrodes provided at intervals in a first predetermined depth position from a toner carrying surface, and a longitudinal direction of each outside electrode crossing a toner carrying direction, an inside electrode provided at least in a portion between the long outside electrodes in a second predetermined depth position deeper than the first predetermined depth; and an insulation layer between a layer having the outside electrodes and a layer having the inside electrode; and a voltage applier configured to apply a voltage which hops toners on the toner carrying surface to the inside electrode and the outside electrodes, the voltage applier configured to apply a voltage made of a DC component and an AC component having a phase opposite to each other to both of the inside electrode and the outside electrodes, or to apply a voltage made of the AC component and the DC component to one of the inside electrode and the outside electrodes and the voltage made of the DC component to the other electrode, and a value of the DC component of the voltage to be applied to each of the inside electrode and the outside electrode being different from one another.

One embodiment of the present invention also provides a process cartridge including the above-described development device.

One embodiment of the present invention also provides an image forming apparatus including the above-described process cartridge.

### BRIEF DESCRIPTION OF THE DRAWINGS

The accompanying drawings are included to provide further understanding of the invention, and are incorporated in and constitute a part of this specification. The drawings illustrate embodiments of the invention and, together with the specification, serve to explain the principle of the invention.

FIG. 1 is a schematic view illustrating a copier according to one embodiment of the present invention.

FIG. 2 is a schematic view illustrating a latent image carrier and a development device in the copier according to one embodiment of the present invention.

FIG. 3 is a view illustrating a toner carrier roller of the development device as seen from the direction orthogonal to the rotation axis according to one embodiment of the present invention.

FIG. 4 is a sectional view illustrating the toner carrier roller in FIG. 3 divided along the plane orthogonal to the rotation axis.

FIGS. 5A, 5B, 5C, 5D are charts each illustrating one example of an inside voltage and outside voltage which are applied to an inside electrode and an outside electrode of the toner carrier roller, respectively: FIG. 5A illustrates an example of a rectangular wave (Duty: 50%); FIG. 5B illustrates an example of a rectangular wave (Duty: 25%): FIG. 5C illustrates an example of a triangular wave, FIG. 5D illustrates an example of saw wave; and FIG. 5E illustrates an example of a sine wave.

FIG. 6 is a chart illustrating another example of an inside voltage and outside voltage which are applied to an inside electrode and an outside electrode, respectively.

FIG. 7 is a chart illustrating another example of inside voltage and outside voltage which are applied to an inside electrode and an outside electrode, respectively.

FIG. 8 is a view illustrating a method of feeding power to the inside electrode and the outside electrode.

FIG. 9 is a perspective view illustrating a method of supplying power to the inside electrode and the outside electrode.

FIG. 10 is a view illustrating a method of feeding power to the inside electric pole and the outside electric pole in Embodiment 2.

FIG. 11 is a view describing the method of feeding power in FIG. 10.

FIG. 12 is a perspective view illustrating the method of feeding power in FIG. 10.

FIG. 13 is a view illustrating a development device in Embodiment 3.

FIG. 14 is a view illustrating a development device in Embodiment 4.

FIG. 15 is a view illustrating a development device in Embodiment 5 together with a photoreceptor.

FIG. 16 is a view illustrating another example of a collection mechanism in the development device.

FIG. 17 is a view illustrating another example of a collection mechanism in the development device.

FIG. 18 is a view illustrating another example of a collection mechanism in the development device.

FIG. 19 is a view illustrating a toner carrier roller of a development device and the circumference of the roller in Embodiment 6.

FIG. 20 is a sectional view illustrating a part of the toner carrier roller in Embodiment 7 which is cut along the plane orthogonal to the rotation axis.

FIG. 21 is a view illustrating electric force lines in the toner carrier roller in Embodiment 7.

### DETAILED DESCRIPTION OF THE PREFERRED EMBODIMENT

Hereinafter, an embodiment in which the present invention is used in a copier as an electrophotographic image forming apparatus will be described.

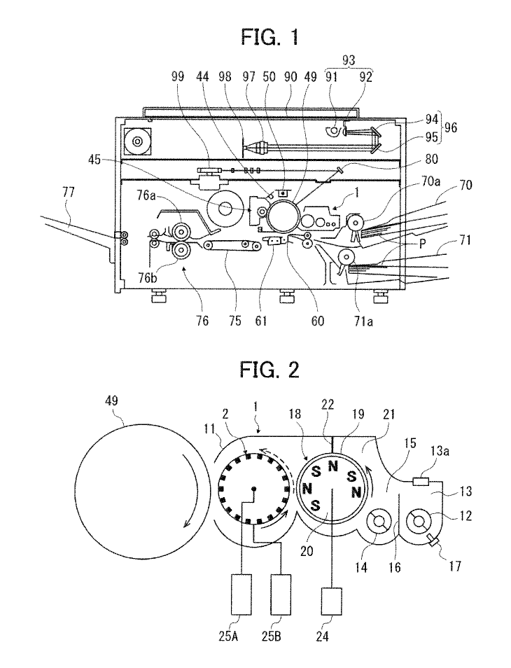

FIG. 1 is a schematic view illustrating a copier according to the present embodiment.

A drum-like photoreceptor 49 as a latent image carrier rotates in the clockwise direction in FIG. 1. If an operator puts a not shown document on a contact glass 90, and presses a not shown print start switch, a first scanning optical system 93 having a document illumination light source 91 and a mirror 92 and a second scanning optical system 96 having mirrors 94, 95 move to read an image of the document. The scanned image is read as image signals by an image reading element 98 disposed behind a lens 97, and the read image signals are processed after being digitized. A laser diode (LD) is driven by signals after the imaging process. After the laser light from the laser diode is reflected by a polygon mirror 99, the laser light scans the photoreceptor 49 through a mirror 80. Prior to this scanning, the photoreceptor 49 is uniformly charged by a charging device 50, and an electrostatic latent image is formed on the surface of the photoreceptor 49 by the scanning of the laser light.

The toners are transferred onto the electrostatic latent image formed on the surface of the photoreceptor 49 by the development process of a development device 1, and the toner image is thereby formed. This toner image is carried to the transfer position which is a position facing a transfer charger 60 with the rotation of the photoreceptor 49. Recording paper P is fed to the transfer position from a first paper feeding portion 70 having a first paper feeding roller 70a and a second paper feeding portion 71 having a second paper feeding roller 71a so as to synchronize with the toner image on the photoreceptor 49. The toner image on the photoreceptor 49 is transferred onto the recording paper P by the corona discharge of the transfer charger 60.

The recording paper P onto which the toner image is transferred as described above is separated from the surface of the photoreceptor 49 by the corona discharge of a separation charger 61. After that, the recording paper P is fed to a fuser 76 by a transfer belt 75. Then, the recording paper P is sandwiched with a fusing nip by the contact of a fusing roller 76a having inside thereof a not shown heat generation source such as a halogen lamp and a pressure roller 76b which presses to the fusing roller. After that, the toner image is fused on the surface by the pressure and heating in the fusing nip, and the recording paper P is discharged to an external paper discharge tray 77.

The remaining toners transferred onto the surface of the photoreceptor 49 which has passed through the above transfer position are eliminated from the surface of the photoreceptor 49 by a cleaning device 45. The surface of the photoreceptor 49 to which the cleaning process is performed is electrically neutralized by a neutralization lamp 44, and is prepared for next latent image formation.

FIG. 2 is a schematic view illustrating the photoreceptor (latent image carrier) 49 and the development device 1 in the copier according to the present embodiment.

The drum-like photoreceptor 49 rotates in the clockwise direction in the figure by a not shown driver. The development device 1 including a toner carrier roller 2 as a toner carrier is disposed in the right side of the photoreceptor 49 in the figure. The development device 1 includes a first container 13 having inside thereof a first transfer screw 12 rotating in the clockwise direction in FIG. 2 and a second container 15 having inside thereof a second transfer screw 14 rotating in the counterclockwise direction. A partition 16 is provided between the first and second containers. Each of the containers contains mixture in which magnetic carriers and negatively-charged toners are mixed.

The first transfer screw 12 carries the mixture in the first container 13 by the rotation from the front side to the back side in the figure while agitating the mixture. In this case, the toner concentration of the mixture is detected by a toner concentration sensor 17 fixed in the bottom portion of the first container 13. The mixture carried near the end portion in the back side in FIG. 2 enters the second container 15 through a not illustrated first communication port provided near the end portion of the partition 16 in the back side. The second container 15 communicates with a magnetic brush forming portion 21 having inside thereof an after-described toner supply roller 18 as a developer supply member. The second transfer screw 14 faces the toner supply roller 18 through a predetermined interval in a state in which the axial directions are parallel to each other. The second transfer screw 14 in the second container 15 carries the mixture in the second container 15 by the rotation from the back side to the front side in FIG. 2 while agitating the mixture. In this process, a part of the mixture carried by the second transfer screw 14 is transferred onto a toner supply sleeve 19 of the toner supply roller 18. After passing through the after-described toner supply position along the rotation of the toner supply sleeve 19 in the counterclockwise direction in the figure, the mixture is separated from the surface of the toner supply sleeve 19 and is sent back to the second container 15. After that, the mixture carried near the end portion of the front side in FIG. 2 by the second transfer screw 14 is sent back to the first container 13 via a not shown second communication port provided near the end portion of the front side of the partition 16 in FIG. 2.

The toner concentration sensor 17 includes a magnetic permeability sensor. The result of the magnetic permeability of the mixture by the toner concentration sensor 17 is sent to a not shown controller as voltage signals. The magnetic permeability of the mixture shows the correlation with the toner concentration of the mixture, so that the toner concentration sensor 17 outputs a voltage value according to the toner concentration.

A not shown controller of the copier includes a RAM (Random Access Memory), and the RAM stores Vtref, which is a target value of the output voltage from the toner concentration sensor 17. The output voltage value from the toner concentration sensor 17 is compared with Vtref in the RAM, and a not shown toner supply device is driven for a time according to the compared result. By this driving, the appropriate amount of toners are supplied in the first container 13 from a toner supply port 13a to the mixture in which the toner concentration is reduced by the toner consumption with the development. Therefore, the toner concentration of the mixture in the second container 15 is maintained in a predetermined range.

The toner supply roller 18 includes the cylindrical toner supply sleeve 19 made of a non-magnetic material, which rotates in the counterclockwise direction in the figure and a magnet roller 20 which is fixed inside the toner supply sleeve 19. The cylindrical toner supply sleeve 19 is made by forming a non-magnetic body such as aluminum, brass, stainless steel, or conductive resin into a cylindrical shape. The magnet roller 20 includes a plurality of magnetic poles (N-pole, S-pole, N-pole, S-pole, N-pole, S-pole in the counterclockwise direction in FIG. 2). By these magnetic poles, the mixture is absorbed on the circumferential surface of the toner supply sleeve 19, and a magnetic brush which is napped in the magnetic force lines is thereby formed.

The mixture transferred onto the surface of the toner supply sleeve 19 rotates in the counterclockwise direction in the figure with the rotation of the toner supply sleeve 19. Then, the mixture enters the carrying amount regulation position, which is a position facing a control member 22 which is disposed to face the surface of the toner supply sleeve 19, at a predetermined interval. In this case, the carrying amount of the mixture on the surface of the sleeve is controlled by passing through the interval between the control member 22 and the surface of the sleeve.

The toner carrier roller 2 rotates in the counterclockwise direction by a not shown driver while having a predetermined interval to the surface of the toner supply sleeve 19 in the left side of the toner supply sleeve 19 in the figure. The mixture which has passed through the above-described carrying amount control position with the rotation toner supply sleeve 19 enters the toner supply position which is a contact position with the toner carrier roller 2. The leading end of the magnetic brush made of the mixture thereby scrubs the surface of the toner carrier roller 2. By this scrubbing and the electric potential difference between the toner supply sleeve 19 and the toner carrier roller 2, the toner in the magnetic brush is supplied on the surface of the toner carrier roller 2. In addition, the supply bias is applied to the toner supply sleeve 19 by a supply bias power source 24 which is a voltage applier. This supply bias can be a DC voltage or can be a voltage in which an AC voltage is superimposed to the DC voltage as long as it can form an electric field which moves the toners on the toner carrier roller 2 side.

The mixture on the toner supply sleeve 19 which has passed through the toner supply position is carried to the position facing the second container 15 with the rotation of the sleeve. Since a magnetic pole is not provided in the magnet roller 20 near that position facing the second container 15, and a magnetic force which transfers the mixture on the surface of the sleeve is not obtained, the mixture is separated from the surface of the sleeve and is sent back to the second container 15. In addition, as the magnet roller 20, a magnet roller having six magnetic poles is used, but the number of magnetic poles is not limited to six, and a magnetic roller having eight magnetic poles or twelve magnetic poles can be used, for example.

A part of the outer circumferential face of the toner carrier roller 2 having the supplied toners is exposed from the opening provided in the casing 11 of the development device 1. This exposed portion faces the photoreceptor 49 via an interval of several tens of μm or several hundreds μm. The position where the toner carrier roller 2 faces the photoreceptor 49 is a development area in the copier.

The toners supplied on the surface of the toner supply roller 2 are carried to the development position from the toner supply position with the rotation of the toner carrier roller 2 while hopping on the surface of the toner carrier roller 2 for the following reason. The toners carried to the development area are transferred to the electrostatic latent image portion on the surface of the photoreceptor by the development electric field between the toner carrier roller 2 and the electrostatic latent image on the photoreceptor 49, and the development is thereby performed. The toners which are not used for the development are carried by the rotation of the toner carrier roller 2 while hopping, and are used again.

Next, the specific configuration of the toner carrier roller 2 as a toner carrier in this embodiment will be described.

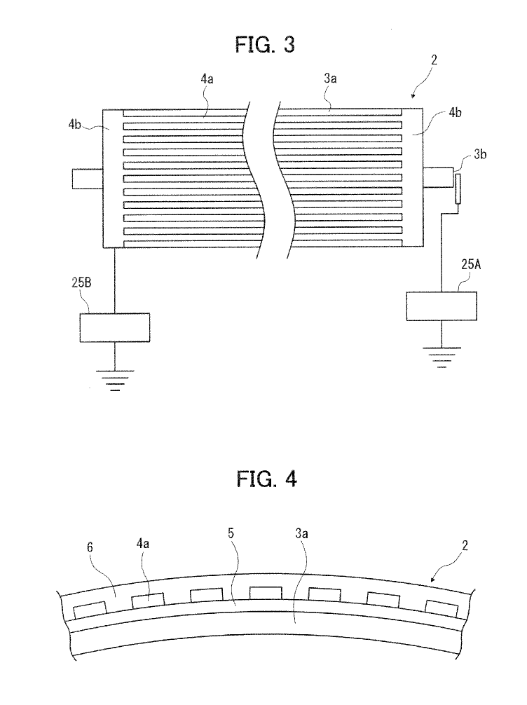

FIG. 3 is a view illustrating the toner carrier roller 2 as seen from the direction orthogonal to the rotation axis for describing the electrode arrangement of the toner carrier roller 2 in the present embodiment. In addition, a surface layer 6 and an insulation layer 5 are omitted in FIG. 3.

FIG. 4 is a partial cross sectional view schematically illustrating a cross section when the toner carrier roller 2 in the present embodiment is cut in the plane orthogonal to the rotation axis.

The toner carrier roller 2 of the present embodiment is made of a hollow roller member, and includes a plurality of long outside electrodes 4a and an inside electrode 3a. The outside electrodes 4a are provided at predetermined intervals in a first predetermined depth position from the toner carrying surface such that the longitudinal direction crosses to the toner carrying direction, and the inside electrode 3a is provided in a second predetermined depth position which is deeper than the first predetermined depth. The outside electrodes 4a can be a comb shape in which the end portions of the outside electrodes are connected by connection portions. An insulation layer 5 which insulates between the inside electrode 3a and the outside electrodes 4a is provided therebetween. A surface layer 6 as a protection layer which covers the outer circumferential surface of the outside electrodes 4a is provided. More specifically, the toner carrier roller 2 of the present embodiment includes a four-layered configuration having, in order from the inner circumference side, the inside electrode 3a, the insulation layer 5, the outside electrodes 4a and the surface layer 6.

The inside electrode 3a is also used as a base body of the toner carrier roller 2, and is made of a metal roller in which a stainless steel or aluminum conductive material is cylindrically molded. The inside electrode 3a is made by forming a conductive layer made of a metal layer such as aluminum or copper on the surface of the resin roller made of polyacetal (POM), polycarbonate (PC) or the like. As a method of forming such a conductive layer, a method by metallic plating, evaporation coating or the like, a method of bonding a metal film on the roller surface or the like is used.

The outer circumferential surface of the inside electrode 3a is covered by the insulation layer 5. In this embodiment, this insulation layer 5 is made of polycarbonate, alkydmelamine or the like. It is preferable for the thickness of the insulation layer 5 to be within the range of 3 μm or above and 50 μm or below. If the thickness becomes below 3 μm, the insulation property between the inside electrode 3a and the outside electrode 4a can not be sufficiently maintained, so that leakage may occur between the inside electrode 3a and the outside electrodes 4a. On the other hand, if the thickness becomes above 50 μm, it becomes difficult to form the electric field between the inside electrode 3a and the outside electrodes 4a outside of the surface layer 6, so that it becomes difficult to form a strong electric field (external electric field) for the flare (hopping) outside the surface layer 6. In this embodiment, the thickness of the insulation layer 5 made of melamine resin is 20 μm. Such an insulation layer 5 can be formed with an equal film layer on the inside electrode 3a by a spray method, a dipping method or the like.

The outside electrodes 4a are provided on the insulation layer 5. These outside electrodes 4a are formed by metal such as aluminum, copper, silver or the like. As a method of forming the comb-shaped outside electrode 4a in which the long electrodes are connected, a method of forming a metal film on the insulation layer 5 by plating or evaporation coating, and forming the comb-shaped electrode by photoresist etching is used. A method of forming the comb-shaped electrode by adhering conductive paste on the insulation layer 5 by an ink-jet method or screen printing can be used.

However, a method of forming the electrode by aluminum generally includes a dipping method using a melted aluminum bath or an evaporation coating method. These methods are performed under high temperature, so that the resin material of the insulation layer may not have an ability to tolerate the high temperature. For this reason, it is preferable to form the electrode by silver, copper or solder, which can be formed at relatively low costs at a lower temperature.

In the present embodiment, the outside electrode is made of silver, copper, lead, tin or alloy of these. Hereinafter, this electrode is referred to as an electrode A. The inside electrode is made of a conductive material in addition to the above-described conductive material. Hereinafter, the inside electrode is referred to as an electrode B. The inside electrode as the electrode B includes a metallic roller which is made of an aluminum cylinder, and the outside electrode as the electrode A includes an electrode made by adhering the silver paste with screen printing (however, the inside electrode can be made of silver, copper, lead tin or alloy of these, and the outside electrode can be made of a conductive material in addition to these).

The outer circumferential faces of the outside electrode 4a and the insulation layer 5 are covered by the surface layer 6. The toners are charged by the contact friction with the surface layer 6 when repeating the hopping on the surface 6. In order to provide a regular charging electrode (negative polarity in this embodiment), silicone, nylon, urethane, alkydmelamine, polycarbonate or the like is used as the material of the surface layer 6. In this embodiment, polycarbonate is used. The surface layer 6 is also used to protect the outside electrode 4a. Therefore, it is preferable for the thickness of the surface layer 6 to be the range of 3 μm or above and 40 μm or below. If the thickness is below 3 μm, the outside electrode 4a is exposed by the removal of the film due to the use over years, so that the applied voltage may leak through the toners carried on the toner carrier roller 2 or another member which has contact with the toner carrier roller 2. On the other hand, if the thickness is above 40 μm, it becomes difficult to form the electric field between the inside electrode 3a and the outside electrode 4a outside the surface layer 6, so that it becomes difficult to form a strong electric field for the flare outside the surface layer 6.

In the present embodiment, the film thickness of the surface layer 6 is set to 20 μm. Such a surface layer 6 can be formed by a spray method, a dipping method or the like similar to the insulation layer 5.

In the present embodiment, the electric field formed between the inside electrode 3a and the outside electrode 4a, specifically, the electric field formed between a part of the inside electrode 3a which does not face the outside electrode 4a (the interval portion between the long outside electrodes 4a) and the outside electrode 4a is formed outside the surface layer 6, so that the toners on the toner carrier roller 2 hops, and the toners are thereby clouded. In this case, the toners on the toner carrier roller 2 reciprocate between the surface layer portion facing the inside electrode 3a through the insulation layer 5 and the surface layer portion facing the adjacent outside electrode 4a while hoppling, and are carried to the development area of the latent image carrier by hopping.

In order to stably cloud the toners, it is important to form the electric field for the flare (hopping) corresponding to the toners. It is necessary to form a large electric potential difference between the inside electrode 3a and the outside electrode 4a in order to form the large electric field for the flare. However, it is important to effectively and stably insulate between the inside electrode 3a and the outside electrode 4a to prevent the leakage in order to stably form a large electric potential difference.

When the two types of long electrodes are alternately provided at intervals (two types of long comb-shaped electrodes are concentrically arranged, and one comb-shaped electrode is fitted to the other comb-shaped electrode) in order to form the electric field for the flare as the conventional technique, if the quality of forming these electrodes is deteriorated, the insulation property between the two types of electrodes is remarkably lowered, and leakage usually occurs. Specifically, for example, a part of a metal film which should be removed may remain when forming the electrode by etching or the conductive paste may adheres between the electrodes when forming the electrodes by an inkjet method or a screen printing method. In this case, leakage is likely to occur between the two types of electrodes, and an appropriate electric field for the flare can not be formed. In the conventional configuration, even if a high-quality comb-shaped electrode is formed on the resin surface of the roller, the insulation property between the electrodes is obtained by providing the insulation material between the electrodes by covering the outer circumferential surfaces of the electrodes after forming the two types of comb-shaped electrodes, so that the interface between the resin surface of the roller and the insulation material is formed between the electrodes. For this reason, the leakage through this interface tends to take place, and the insulation property between the electrodes is remarkably deteriorated if a large voltage is applied.

However, according to the above-described embodiment of the present invention, the toner carrier roller includes a plurality of long outside electrodes 4a arranged in the first predetermined depth position from the toner carrier surface at predetermined intervals, the longitudinal direction of each outside electrode 4a crossing to the toner carrying direction, the inside electrode 4a arranged in the second predetermined depth position deeper than the first predetermined depth, the inside electrode 4a being provided at least in the position corresponding to the interval portion of the outside electrodes 4a, and the insulation layer 5 between the layer having the outside electrodes 4a and the layer having the inside electrode 3a. Consequently, the interface which becomes the cause of the leakage is not formed between the inside electrode 3a and the outside electrodes 4a.

Moreover, in the manufacturing step of the toner carrier roller 2, the possibility that the conductive material which becomes the cause of the leakage is provided between the two types of electrodes can be reduced. Therefore, according to the present embodiment, the insulation between the inside electrode 3a and the outside electrodes 4a can be stably and effectively obtained, and the leakage can be effectively prevented even if a relatively large voltage is applied.

In the present embodiment, it is preferable for the thickness of the long outside electrode 4a to be 10 μm or above and 120 μm or below. If the thickness is below 10 μm, the electrode may be broken because it is too thin. On the other hand, if the thickness is above 120 μm or more, the voltage which is applied to a part of the outside electrode 4a far from a power-fed portion 4b is reduced, so that it becomes difficult to effectively and stably hop the toners in that portion, and it becomes difficult to carry the toners to the development area of the latent image carrier. As a result, the unevenness is generated on an image in the width direction.

The power-fed portion 4b of the present invention is provided in both ends on the outer circumferential surface of the toner carrier roller 2 in the axial direction. More specifically, both end portions of the long outside electrodes 4a are connected to each other by the power fed portions 4b. In this case, if the width of the outside electrode 4a is above 120 μm, the electric field for the flare in the central portion of the toner carrier roller 2 in the axial direction becomes lower than the electric field for the flare of both end portions of the toner carrier roller 2 in the axial direction, so that it becomes difficult to stably and effectively hop the toners carried on the central portion of the toner carrier roller 2 in the axial direction.

In the present embodiment, it is preferable for the distance between the outside electrodes 4a to be the same as the width of the electrode or to be wider than the width of the electrode. If the distance is shorter than the width of the electrode, a lot of electric force lines from the inside electrode 3a are converged to the outside electrode 4a before coming outside the surface layer 6. On the other hand, if the distance between the outside electrodes 4a is long, the electric field for the flare in the center between the electrodes is reduced in strength. Accordingly, it is preferable for the distance between the outside electrodes 4a to be the range of the electrode width or more and 5 times the electrode width or below.

In the present embodiment, the width of the outside electrode 4a and the distance between the outside electrodes 4a are set to 80 μm, respectively.

In the present embodiment, the pitch of the outside electrodes 4a (the sum of the width of the outside electrode 4a and the distance between the outside electrodes 4a) is set to be a constant over the toner carrier roller 2 in the circumferential direction. By setting the pitch of the electrodes to be constant, the electric field for the flare formed between the inside electrode 3a and the outside electrode 4a becomes substantially equal over the toner carrier roller 2 in the circumferential direction. Accordingly, the equal hopping of the toners in the development position in the circumferential direction can be achieved, and an image can be uniformly developed.

Next, the voltage which is applied to the inside electrode 3a and the outside electrode 4a will be described.

A voltage applier is connected to the inside electrode 3a and the outside electrode 4a of the toner carrier roller 2. The voltage applier is configured to apply a voltage including a DC component and an AC component each having a reversed phase to both of the inside electrode 3a and the outside electrode 4a, respectively, or is configured to apply a voltage including an AC component and a DC component to one of the inside electrode and the outside electrode and to apply the DC voltage to the other electrode.

Specifically, as the voltage appliers, the power sources 25A, 25B apply the inside voltage of the first voltage and the outside voltage of the second voltage to the inside electrode 3a and the outside electrodes 4a, respectively. It is most preferable for the inside voltage and the outside voltage which are applied by the power sources 25A, 25B to be rectangular waves each having a reversed phase because the difference between the inside voltage and the outside voltage can be constantly maximized. The duty of the rectangular wave can be changed. However, it can not be limited to the rectangular wave, and it can be a sine wave, a triangular wave or a saw wave.

In the present embodiment, the two-phase configuration of the inside electrode 3a and the outside electrode 4a is used for the electrode for forming the flare. The voltage including an AC component each having a phase difference π, namely, the voltage including an AC component each having a reversed phase is applied to the electrodes 3a, 4a, respectively.

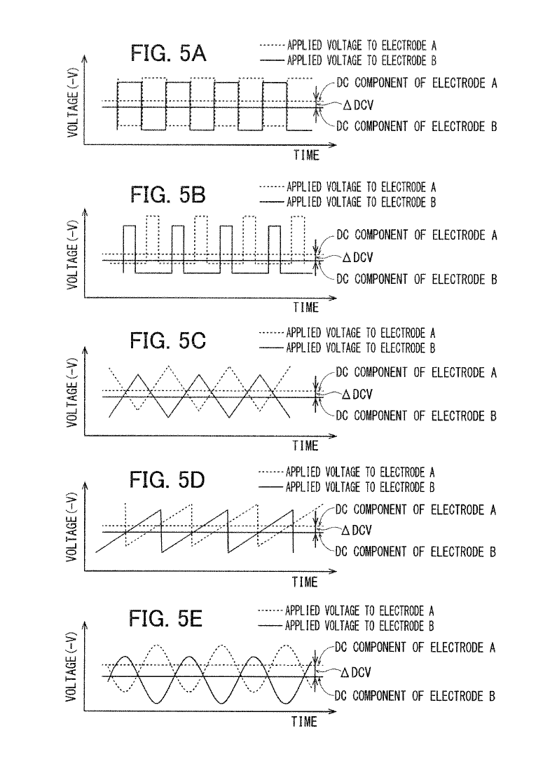

FIGS. 5A-5E are views each illustrating an example of the voltage which is applied to the electrode A and the electrode B.

FIG. 5A is an example in which the duty of the rectangular wave is set to 50%. FIG. 5B is an example in which the duty of the rectangular wave is reduced to 25%. FIG. 5C is an example using an AC component of a triangular wave, FIG. 5D is an example using an AC component of a saw wave and FIG. 5E is an example using an AC component of a sine wave. The AC components of the respective examples are the same size voltage (Vpp, peak to peak voltage) in which each phase is shifted by π. In addition, ΔDCV is a difference of the DC components of these voltage in the examples.

There is a difference between the value of the DC component of the voltage to be applied to the electrode A and the value of the DC component of the voltage to be applied to the electrode B (ΔDCV in FIGS. 5A-5E). If the DC component of the voltage to be applied to the electrode A is set to smaller than the DC component of the voltage to be applied to the electrode B (is set to the negative side), since the metallic ions (Ag⁺, Cu²⁺, Sn²⁺, Sn⁴⁺, Pb²⁺) which are generated by the ion migration of the material of electrode A such as silver, copper, lead, tin or an alloy of these over time have a positive polarity, these ions are attracted by the electrostatic attractive force of the electrode A having a negative polarity by the above-described voltage application, and are prevented from being moved to the electrode B. As just described, the metallic ions do not move to the electrode B from the electrode A in the insulation layer, so that the leakage between the electrode A and the electrode B by the ion migration can be prevented. In this case, the difference (absolute value) between the sizes of the DC components of the voltage to be applied to the electrode A and the electrode B, respectively, has to be smaller than the peak to peak voltage Vpp of each voltage. If the difference of the sizes of the DC components is larger than Vpp, the direction of the electric field on the roller surface does not change, and the electric field for hopping toners, namely, the electric field for the flare is not generated. In the present embodiment, the difference (absolute value) of the sizes of the DC components of the voltage to be applied to the electrodes A, B is set to above 0V and 100V or below.

The voltage applier which applies such voltage can be formed from, for example, a waveform generation circuit including a CPU, a D/A convertor, and an OP amp and a high voltage amp.

By applying the above-described voltage, the electric potential difference by VPP±“difference between DC components” is generated between the electrode A and the electrode B. The electric field is generated between the electrodes by the electric potential difference, so that the toners hop on the surface layer 6 by the electric field for the flare formed outside the surface layer 6. In the present embodiment, it is preferable for the electric potential difference between the electrode A and the electrode B (namely, Vpp±“difference between DC components”) to be within the range of 100V or above and 2000V or below. If the electric potential difference is below 100V, the sufficient electric field for the flare can not be formed on the surface layer 6, and it becomes difficult to stably hop the toners to carry the toners. On the other hand, if the electric potential difference is above 2000V, the leakage is more likely to occur between the electrodes with long-term use. In the present embodiment, Vpp is set to 500V.

The average value of the voltage (namely, the voltage of the DC component to be applied to the electrode A and the electrode B) is set between the electric potential of the image portion (the electric potential of the electrostatic latent image portion) and the electric potential of the non-image portion (the electric potential of the background portion), and can be appropriately optimized according to the development condition.

In the present embodiment, the center value V0 of the inside voltage and the outside voltage is set between the electric potential of the image portion (the electric potential of the electrostatic latent image portion) and the electric potential of the non-image portion (the electric potential of the background portion), and is appropriately optimized according to the development condition.

In the present embodiment, it is preferable for the frequency f of the AC component of the inside voltage and the outside voltage to be 0.1 kHz or above and 10 kHz or below. Namely, if the frequency f is below 0.1 kHz, the hopping of the toners can not follow the development speed. More specifically, the toner amount required for the development may not be supplied. On the other hand, if the frequency f is above 10 kHz, the movement of the toners can not follow the switching of the electric field, so that it becomes difficult to stably hop the toners, and the toner amount required for the development may not be supplied. In the present embodiment, the frequency f is set to 500 Hz.

In order to hop the toners, it is not always necessary for both of the inside voltage and the outside voltage to be the voltage made of the DC component and the AC component. One voltage can be the voltage made of the DC component and the AC component and the other voltage can be the DC voltage.

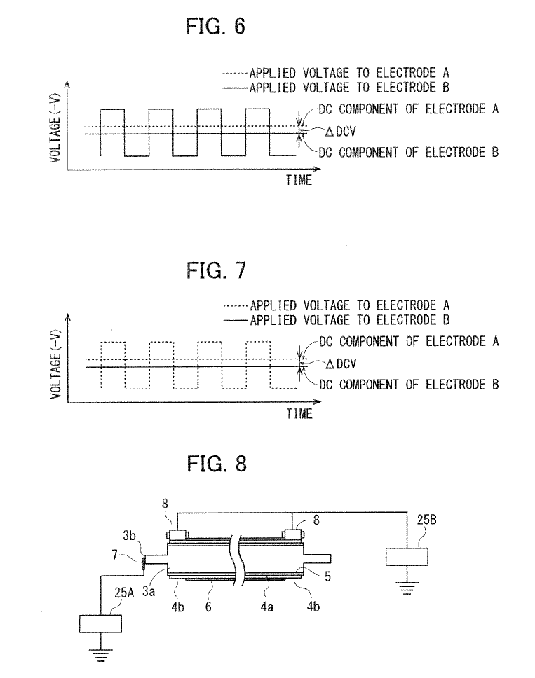

FIG. 6 is a chart illustrating another example of the inside voltage and the outside voltage to be applied to the inside electrode 3a and the outside electrode 4a, respectively, when the inside electrode 3a is the electrode B and the outside electrode 4a is the electrode A.

In this example illustrated in FIG. 6, the inside voltage similar to the voltage illustrated in FIG. 5A is applied to the inside electrode 3a, but the DC voltage (only DC component) is applied to the outside electrode 4a. In this case, the electric potential difference between the electrodes becomes Vpp/2±“difference of DC components” of the inside electrode. Therefore, it is preferable for Vpp of the inside voltage in this example to be 200V or above and 4000V or below. According to this example, it is not necessary to consider the phase difference between the inside electrode 3a and the outside electrode 4a; thus, the power source costs and the device costs can be lowered.

FIG. 7 is a chart illustrating another example of the inside voltage and the outside voltage to be applied to the inside electrode 3a and the outside electrode 4a, respectively, when the inside voltage 3a is the electrode B and the outside electrode 4a is the electrode A.

In this example, the inside voltage similar to the voltage illustrated in FIG. 5 is applied to the outside electrode 4a, but the DC voltage is applied to the inside voltage 3a. In this case, the electric potential difference between the electrodes becomes Vpp/2±“difference of DC components”. Therefore, it is preferable for the range of the Vpp of the outside voltage in this embodiment to be 200V or above and 4000V or below. According to this example, it is not necessary to consider the phase difference between the inside electrode 3a and the outside electrode 4a; thus, the power source costs can be lowered.

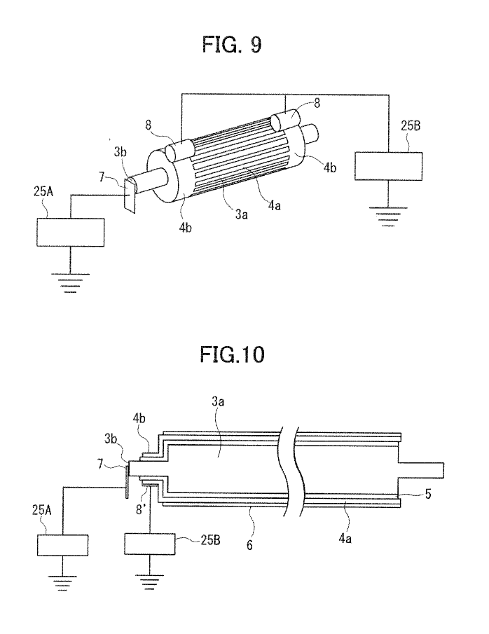

FIG. 8 is a view illustrating the configuration which feeds power to the inside electrode 3a and the outside electrode 4a in the present embodiment. FIG. 9 is a perspective view illustrating the configuration of FIG. 8.

In this example, the inside electrode 3a is integrated with the axis of the toner carrier roller 2, and the end face of the roller axis becomes a power-fed portion 3b. A power feeding brush 7 as a first power feeding member connected to the power source 25A has contact with the power-fed portion 3b made of the end face of the roller axis. The surface layer 6 is not provided in both end portions of the outer circumferential surface of the toner carrier roller 2. Both end portions of the outside electrode 4a on the outer circumferential surface of the toner carrier roller 2 (the connection portions provided in both ends of the long electrode) are exposed, and these exposed surfaces become the power-fed portions 4b. The power feeding roller 8 as a second power feeding member connected to the power source 25B has contact with the power-fed portion 4b. The power feeding roller 8 is rotatably supported and rotates with the rotation of the toner carrier roller 2 while having contact with the power-fed portion 4b, and is electrically connected to the power-fed portion 4b.

In the present embodiment, the power feeding roller 8 of the second power feeding member which applies the outside voltage to the outside electrode 4a is provided in both ends of the toner carrier roller 2, but the power feeding roller 8 can be provided only in the one end of the roller 2 or a plurality of power feeding rollers 8 can be provided in both ends of the roller 2. If a plurality of second power feeding members which apply outside voltage to the outside electrode 4a is provided, even if a power feeding error occurs in a part of the second power feeding members by the contact error, the power feeding can be performed by another second power feeding member, so that stable power feeding can be conducted.

As the present embodiment, a part of the outside electrode 4a is exposed on the outer circumferential surface of the toner carrier roller 2, the exposed portion is used as the power-fed portion 4b, and the second power feeding member has contact with the power-fed portion 4b for feeding power. In this power feeding method, it is preferable for the power-fed portion 4b to be located outside the development width on the toner carrier roller 2 in the axial direction (the area facing the area in which the electrostatic latent image is formed on the photoreceptor). If the power-fed portion 4b is located in the development width, the toner pressed between the toner carrier roller 2 and the power-fed portion 4b is used for the development, so that a development error may occur in that portion. It is more preferable for the power-fed portion 4b to be located outside the toner supply width on the toner carrier roller 2 (the area to which the toner is supplied from the toner supply sleeve 19) in the axial direction. If the power-fed portion 4b is located in the toner supply width, considerable amounts of toners are provided between the toner carrier roller 2 and the power-fed portion 4b, so that a power feeding error is more likely to occur, but this error is prevented in advance by the above configuration. In the present embodiment, the power-fed portion 4b is located outside the toner supply width on the toner carrier roller 2 in the axial direction. Moreover, in the present embodiment, a not illustrated toner seal is provided in the center of each power-fed portion 4b in the axial direction, which is located in the end portion of the roller, so as to prevent the adhesion of the toners in the toner supply width to the power-fed portion 4b.

In the present embodiment, the power feeding roller 8 rotating with the power-fed portion 4b is used as the second power feeding member, but the second power feeding member is not limited thereto. For example, a conductive brush or a conductive plate spring can be used as the second power feeding member. When the second power feeding member, which slides to the power-fed portion 4b such as a conductive brush or a conductive plate spring, is used, it is preferable to use conductive grease together to control the abrasion of the contact portion with the power-fed portion 4b.

In the above, it is described that the power-fed portion of the inside electrode 3a is the end face of the roller axis, but it is not limited thereto. The circumferential face of the roller axis or the end face of the roller main body can be the power-fed portion, for example.

According to the above-described embodiment, the toner carrier roller 2 as the toner carrier which carries the toners of one-component developer carried on the outer circumferential face to the development area includes the inside electrode 3a as the first electrode member, the outside electrode 4a as the second electrode member which is located outside the inside electrode 3a and to which the outside voltage as the second voltage different from the inside voltage of the first voltage applied to the inside voltage 3a is applied, the insulation layer 5 which insulates between the inside electrode 3a and the outside electrode 4a and the surface layer 6 as the protection layer covering the outer circumferential surface of the outside electrode 4a. An electrode member in addition to the inside electrode 3a and the outside electrode 4a (an electrode member to which a voltage different from the inside voltage and the outside voltage is applied) is not located adjacent to both sides of the insulation layer 5. The surface layer 6 is provided such that a part of the long outside electrode 4a (the connection portion provided in one end or both ends) is exposed in the outer circumferential face, and the exposed portion of the outside electrode 4a is used as the power-fed portion 4b of the outside voltage. By these configurations, the power feeding to the outside electrode 4a located on outer circumferential surface of the toner carrier roller 2 can be performed from the outer circumferential surface, so that the power feeding configuration to the inside electrode 3a located inside the outside electrode 4a is not limited by the power feeding configuration to the outside electrode 4a.

Moreover, the power feeding roller 8, the power feeding brush 8′ or the like, which is the second power feeding portion for feeding the outside voltage to the power-fed portion 4b of the outside electrode 4a, is disposed outside the outer circumference of the toner carrier roller 2 in the normal direction, so that it becomes unnecessary to dispose the power feeding roller 8, the power feeding brush 8′ or the like outside the toner carrier roller 2 in the axial direction. As a result, a space for disposing the power feeding roller 8, the power feeding brush 8′ or the like outside the toner carrier roller 2 in the axial direction becomes unnecessary, and the development device 1 in the axial direction of the toner carrier roller 2 can be thereby downsized.

According to the present embodiment, the insulation layer 5 is provided between the inside electrode 3a and the outside electrode 4a. All the electrodes 3a, 4a provided in the toner carrier roller 2 are divided by the insulation layer 5, so that the interface connecting these electrodes is not provided and the toners are also not provided between the electrodes. Accordingly, the leakage through the toners and the interface does not occur between the electrodes 3a, 4a provided in the toner carrier roller 2.

If one (electrode A) of the inside electrode 3a and the outside electrode 4a is made of silver, copper, lead, tin or an alloy of these and the other electrode (electrode B) is made of a conductive material in addition to the above-described materials, the value in which the DC component of the voltage applied to the electrode B is subtracted from the DC component of the voltage applied to the electrode A becomes minus, so that the metallic ion generated in the electrode A stays on the electrode A, and the migration of the metallic ion inside the insulation layer can be prevented. Accordingly, the leakage by the ion migration can be prevented over years.

In the present embodiment, the outside electrode 4a as the outermost circumferential electrode member located in the outermost circumferential surface includes a plurality of electrode portions divided in the outer circumferential surface of the toner carrier roller 2, and the inside electrode 3a located inside the outside electrode 4a is disposed in the position facing the area between the electrode portions. According to the present embodiment, the leakage does not occur between the electrodes 3a, 4a for forming the electric field for the flare, so that the strong electric field for the flare can be stably formed.

In the present embodiment, the inside electrode 3a as the innermost circumferential electrode portion located in the innermost circumferential surface includes the unified electrode portion such that the electrode portion is located in the positions facing a plurality of electrode portions not only in the positions facing the areas between a plurality of electrode portions in the outside electrode 4a. Consequently, the inside electrode 3a can be formed with a simple method, and the inside electrode 3a can be used as the base body of the toner carrier roller 2.

Hereinafter, another embodiment will be described.

### Embodiment 2

A modified example of the power feeding configuration to the inside electrode 3a and the outside electrode 4a will be described.

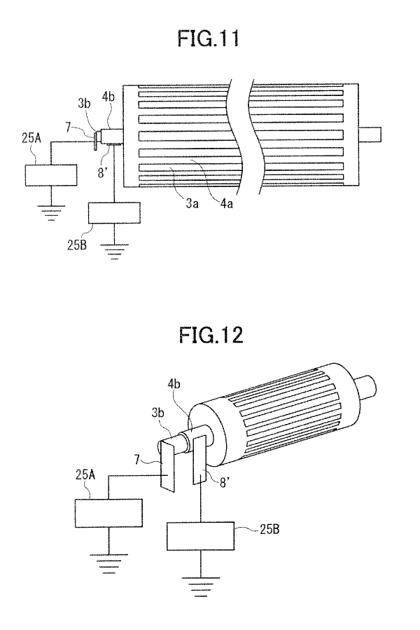

FIG. 10 is a view illustrating the power feeding configuration to the inside electrode 3a and the outside electrode 4a. FIG. 11 is a view as seen from the direction orthogonal to the axial direction. FIG. 12 is a perspective view.

In Embodiment 2, similar to the above embodiment, the power feeding configuration to the inside electrode 3a is configured such that the end surface of the roller axis becomes the power-fed portion 3b, and a power feeding brush 7 has contact with the power-fed portion 3b to be electrically connected thereto. On the other hand, the power feeding configuration to the outside electrode 4a is configured such that the outside electrode 4a is extended on the circumferential face of the roller axis, and the extended portion is used as a power-fed portion 4b. By extending the insulation layer 5 on the circumferential face of the roller axis similarly to the outside electrode 4a, the insulation between the inside electrode 3a and the outside electrode 4a is ensured on the circumferential face of the roller axis. A power feeding brush 8′ as the second power feeding member connected to the power source 25B has contact with the power-fed portion 4b on the circumferential face of the roller axis.

In addition to the power feeding configuration described in Embodiment 2, the roller axis of the toner carrier roller is electrically divided, and the inside electrode 3a and the outside electrode 4a are conducted to any of the axes, and the voltage is applied to each of the inside electrode 3a and the outside electrode 4a through each roller axis.

### Embodiment 3

Next, Embodiment 3 will be described.

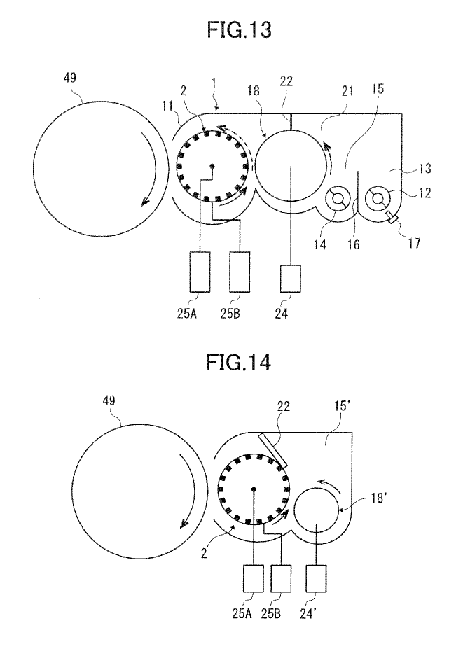

FIG. 13 is a view illustrating a development device in Embodiment 3.

In this embodiment, the toners are supplied to the toner carrier roller 2 without using magnetic carriers. The development device 1 according to this embodiment includes a first container 13 having inside thereof a first carrying screw 12 which rotates in the clockwise direction in the figure and a second container 15 having inside thereof a second carrying screw 14 which rotates in the counterclockwise direction in the figure. A partition 16 is provided between the containers. Each of the containers contains not illustrated negatively-charged toners. The toners are circulated and carried in the first container 13 and the second container 15 by the rotation of the first carrying screw 12 and the second carrying screw 14. In this carrying, the toners are frictionally charged with the first carrying screw 12 and the second carrying crew 14. The frictionally-charged toner in the second container 15 electrostatically absorbs on the toner supply roller 18 to which the supply bias is applied by the supply bias power source 24. In addition, the supply bias can be a DC voltage or AC voltage, or can be bias in which a DC voltage is superimposed on an AC voltage. The toners absorbed on the toner supply roller 18 are carried to the supply position after the carrying amount is controlled by the control member 22. The toners carried to the supply position are supplied on the surface of the toner carrier roller 2 by the electric potential difference of the toner supply roller 18 and the toner carrier roller 2. After that, the process which is the same as that in the above embodiments will be conducted; thus, the description thereof will be omitted.

### Embodiment 4

Next, another example (Embodiment 4) of the configuration which supplies toners to the toner carrier roller 2 will be described.

FIG. 14 is a view illustrating a development device in Embodiment 4.

In Embodiment 4, the toners are supplied to the toner carrier roller 2 without using magnetic carriers similar to Embodiment 3, and the toners are directly supplied to the toner carrier roller 2 without using the toner carrier roller 18.

Specifically, in Embodiment 4, a sponge roller 18′ is provided in a toner container 15′, and the surface of the sponge roller 18′ has contact with the surface of the toner carrier roller 2. The toners transferred on the surface of the sponge roller 18′ in the toner container 15′ are thereby frictionally charged with the contact portion with the surface of the toner carrier roller 2, and are electrostatically supplied to the toner carrier roller 2. In Embodiment 4, the sponge roller 18′ rotates in the trailing direction relative to the toner carrier roller 2, but can rotate in the counter direction. In Embodiment 4, the toner amount to be supplied to the toner carrier roller 2 can be controlled by the supply bias to be applied by a supply bias power source 24′ connected to the sponge roller 18′. This supply bias can be a DC voltage or AC voltage or bias in which an AC voltage is superimposed on the DC voltage.

### Embodiment 5

Next, a modified example (Embodiment 5) of the development device in which a collection mechanism 30 as a collector collecting toners which are not used for the development from the toner carrier roller 2 will be described.

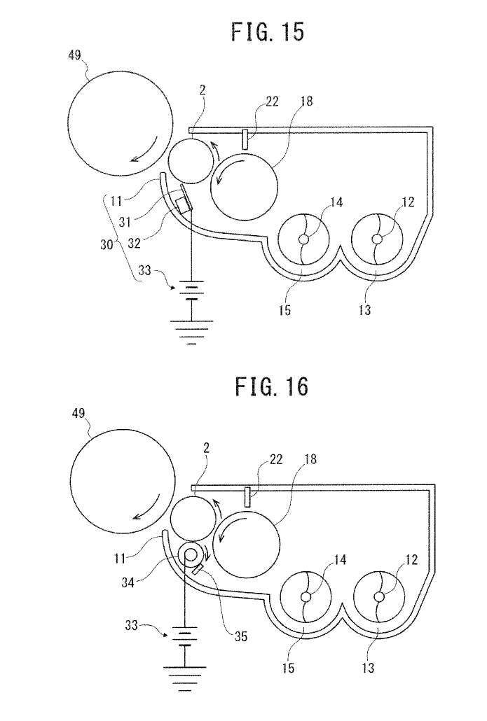

FIG. 15 is a perspective view illustrating the development device in Embodiment 5 with the photoreceptor 49.

The basic configuration of the development device in Embodiment 5 is similar to the above embodiments, but the development device in this embodiment includes the collection mechanism 30 and the configuration in which the inside wall of a casing 11 located on the lower side of the toner carrier roller 2 and the toner supply roller 18 is inclined downwardly toward the second container 15 which contains the second carrying screw 14. These differences will be described below.

In Embodiment 5, the collection mechanism 30 includes a collection plate 31 disposed to face the outer circumferential face of the toner carrier roller 2, a vibrator 32 disposed to have contact with the collection plate 31, and a power source 33 for applying a predetermined voltage to the collection plate 31. An electric field for electrostatically moving the negatively-charged toners toward the collection plate 31 from the toner carrier roller 2 is formed. The toners which are not used for the development in the development area move on the collection plate 31 side from the toner carrier roller 2 in the collection area in which the collection plate 31 faces the toner carrier roller 2. The toners transferred on the collection plate 31 are eliminated from the collection plate 31 by vibrating the collection plate 31 with the vibrator 32. The eliminated toners move on the inside wall face of the casing 11, so as to be returned to the second container 15, and are again circulated and carried in the first container 13 and the second container 15.

FIG. 16 is a schematic view illustrating another example of the collection mechanism 30.

As illustrated in FIG. 16, the configuration using a collection roller 34 can be used as the collection mechanism 30.

Specifically, the collection mechanism 30 includes the collection roller 34 disposed to face the outer circumferential face of the toner carrier roller 2, a cleaning blade 35 disposed to have contact with the collection roller 34, and a collection power source 33 which applies a predetermined voltage to the collection roller 34. An electric field which electrostatically moves the negatively-charged toners toward the collection roller 34 from the toner carrier roller 2 is formed between the toner carrier roller 2 and the collection roller 34. The toners which are not used for the development in the development area are thereby moved on the collection roller 34 side from the toner carrier roller 2 in the collection area where the collection roller 34 faces the toner carrier roller 2. The toners transferred on the collection roller 34 are scraped by the cleaning blade 35. The scraped toners move on the inside wall face of the casing 11, so as to be returned to the second container 15, and are again circulated and carried in the first container 13 and the second container 15.

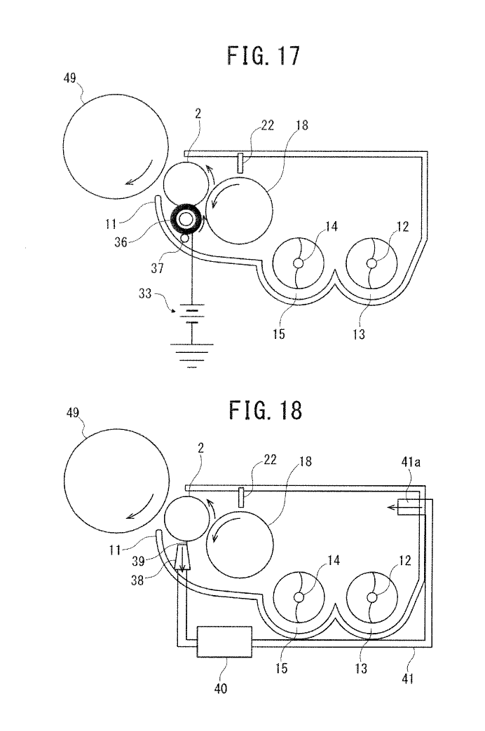

FIG. 17 is a schematic view illustrating another example of the collection mechanism 30.

As illustrated in FIG. 17, the configuration using a brush roller 36 can be used as the collection mechanism 30. Specifically, this collection mechanism 30 includes the brush roller 36 disposed to face the outer circumferential surface of the toner carrier roller 2 and has contact with the outer circumferential surface of the toner carrier roller 2, a flicker 37 disposed to have contact with the brush roller 36 and a collection power source 33 which applies predetermined voltage to the brush roller 36. An electric field which electrostatically moves the negatively-charged toners toward the brush roller 36 from the toner carrier roller 2 is formed between the toner carrier roller 2 and the brush roller 36. The toners which are not used for the development in the development area are thereby moved on the brush roller 36 side from the toner carrier roller 2 in the collection area where the brush roller 36 faces the toner carrier roller 2. The toners transferred on the brush roller 36 are removed by the flicker 37. The scraped toners move on the inside wall face of the casing 11, so as to returned to the second container 15, and are again circulated and carried in the first container 13 and the second container 15.

FIG. 18 is a schematic view illustrating another example of the collection mechanism 30.

As illustrated in FIG. 18, the configuration using a suction pump 40 can be used as the collection mechanism 30. Specifically, the collection mechanism 30 includes a suction nozzle 38 disposed to face the outer circumferential surface of the toner carrier roller 2, a duct 41 having an entrance end connected to the suction nozzle 38 and an exit end 41a that communicates with the upper portion of the first container 13 having inside thereof the first carrying screw 12 and the suction pump 40 which sucks the toners from the suction nozzle 38 and carries the toners to the exit end 41a. A seal member 39 is provided in the downstream side of the surface movement direction of the toner carrier roller 2 relative to the suction nozzle 38. This seal member 39 has contact with the surface of the toner carrier roller 2. The toners which are not used for the development in the development area are sucked in the suction nozzle 38 according to the air flow by the suction pump 40 in the collection area where the toner carrier roller 2 faces the suction nozzle 38, so as to be returned to the first collector 13 from the exit end 41a through the duct 41 and are again circulated and carried in the first container 13 and the second container 15. The toners which have passed through the collection area without moving with the air flow are stopped by the seal member, so that toners are not carried downstream.

### Embodiment 6

Next, a modified example (Embodiment 6) of the development device including a toner collector which collects upstream of the development area toners before development transferred on the non-image portion (background portion) on the photoreceptor 49 in the development area will be described.

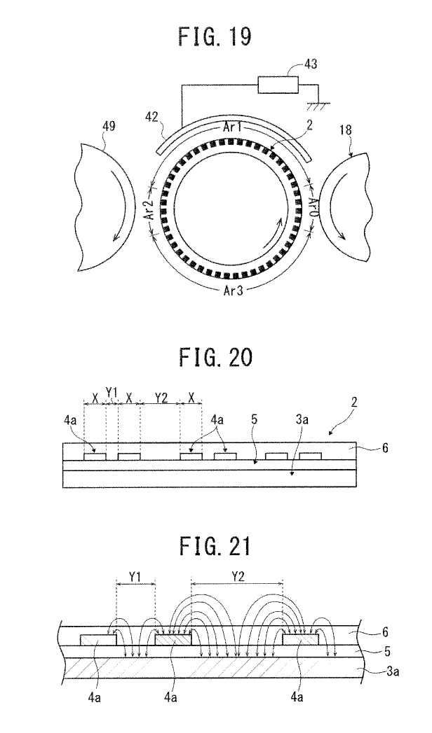

FIG. 19 is an enlarged view illustrating the toner carrier roller 2 of the development device in Embodiment 6 and its circumferential configuration.

Referring to FIG. 19, Ar0 illustrates a toner supply area in which the toner carrier roller 2 has contact with a not illustrated magnetic brush formed on the surface of the toner supply sleeve 19 of the toner supply roller 18, Ar2 illustrates a development area, Ar1 illustrates a carrying area before development as an area which enters in the development area Ar2 after passing through the toner supply area Ar0 in the entire area of the toner carrier roller 2 in the surface movement direction, and Ar3 illustrates a carrying area after development as an area which enters the toner supply area Ar0 after passing through the development area Ar2.

The development area Ar2 is an area where the photoreceptor 49 comes close to the toner carrier roller 2 by the curvature of the photoreceptor 49 in the area where the photoreceptor 49 faces the toner carrier roller 2. The length of the toner carrier roller 2 in the surface movement direction in such a development area Ar2 can be measured as follows. Namely, a solid image formed on the photoreceptor 49 is developed while photographing the behavior of the toners in the development area Ar2 and the area near the development area with a high magnification and a high speed camera. Then, the distance between the position where the toner particles transferred on the upstream end of the photoreceptor of the solid image in the surface movement direction hop at the end on the surface of the toner carrier roller 2 and the position where the toner particles transferred on the downstream end of the photoreceptor of the solid image in the rotation direction hop at the end on the surface of the toner carrier roller 2 is measured. This distance can be a length in the roller rotation direction in the development area Ar2.

The toners hopping in the carrying area Ar1 before development gradually come close to the development area Ar2 with the rotation of the toner carrier roller 2, but the toners include the oppositely-charged toners and also highly-charged toners which are larger on the regular polarity side than the average charging amount. If these oppositely-charged toners and the highly-charged toners are carried to the development area Ar2, they are transferred to the non-image portion (background portion) of the photoreceptor 49, resulting in scumming.

In Embodiment 6, a toner collector which collects the oppositely-charged toners and the highly-charged toners before development of the toners hopping on the surface of the toner carrier roller 2 in the carrying area Ar1 is provided. The collector includes an electrode 42 (facing electrode before development) which faces the carrying area Ar1 at a predetermined interval and also a bias power source 43 (collection bias power source before development) which is a voltage applier which applies a collection bias before development to the electrode 42.

The electrode 42 has at least a curved surface facing the toner carrier roller 2 such that the space with the toner carrier roller 2 becomes equal from the upstream end portion to the downstream end of the toner carrier roller 2 in the rotation direction. This space is set to a value which is the same as that of the development gap of the minimum space between the photoreceptor 49 and the toner carrier roller 2 in the development area Ar2.

The bias power source 43 outputs the bias made of a DC voltage having a polarity and a value which are the same as those of the background portion (uniformly charged electric potential) of the photoreceptor 49. Namely, by applying the bias, the electric potential of the electrode 42 can be a polarity and a value which are the same as those of the background portion on the photoreceptor 49.

The above-described toner collector includes a not illustrated controller which controls the output of the bias from the power source, in addition to the bias power source 43 of the electrode 42. The collection bias is applied to the electrode 42 in the development (in a state in which the toners to be used for the development of the electrostatic latent image are carried in the carrying area Ar1 and the development area Ar2). According to this configuration, the toners which cause scumming by transferring to the background portion of the photoreceptor 49 in the development area Ar2, namely, the oppositely-charged toners and the highly-charged toners are selectively transferred to the electrode 42 in the toners hopping in the carrying area Ar1. The toners which cause the scumming are thereby selectively separated from the toners which are carried in the carrying area Ar1.

After completing the development operation (continuous development operation in continuous printing), the controller switches the output voltage from the bias power source 43 by the control signal from the above-described collection bias to the discharge bias which is large on the polarity of the charged toner (large on the negative side in this embodiment) from the collection bias. Therefore, the oppositely-charged toners and the highly-charged toners transferred to the electrode 42 are discharged on the surface of the toner carrier roller 2 after being separated from the electrode 42. Then, after passing through the development area Ar2 and the carrying area Ar3, the toners are collected in the magnetic brush in the toner supply area Ar0.

It is preferable to apply to the discharged bias large AC voltage covering the positive side and the negative side relative to the central value of the voltage which is applied to the electrode of the toner carrier roller 2. Thereby, the toners between the toner carrier roller 2 and the bias power source 43 reciprocate, and the toners are easily released from the adhesion with the bias power source 43. The toners on the bias power source 43 are thereby restricted in the electric field for the flare generating between the electrodes of the toner carrier roller 2, and can be effectively carried with the rotation of the toner carrier roller 2.

In the configuration which electrostatically supplies the toners to the toner carrier roller 2 by applying the supply bias to the not illustrated toner supply roller, it is preferable to stop the application of the supply bias to the toner supply roller 18, 18′ when returning the oppositely-charged toners and the highly-charged toners transferred to the electrode 42 by applying the discharged bias to the electrode 42. In this case, the oppositely-charged toners and the highly-charged toners can be returned on the toner carrier roller 2 having a small amount of toner adhesion.

In addition, a method of eliminating the oppositely-charged toners and the highly-charged toners transferred to the electrode 42 from the electrode 42 is not limited to a method of applying the discharged bias to the electrode 42. For example, a method of scraping the oppositely-charged toners and the highly-charged toners transferred to the electrode 42 by a brush roller, a method of eliminating the oppositely-charged toners and the highly-charged toners transferred to the electrode 42 by scanning in the axial direction with an elimination member having a blade or the like is used.

Since the highly-charged toners which are carried on the carrying area Ar1 are large in the charging amount compared to another toner, the highly-charged toners hop higher than another toner. When the toners reach the highest level by the hopping, the toner cloud is located on the lower side, so that the toners may scatter by the repulsion to the area which is not restricted by the electric field on the toner carrier roller 2. However, such scattering of the highly-charged toners can be prevented by providing the electrode 42.

It is desirable to use as the electrode 42 an electrode in which the surface of the electrode layer made of a metallic conductive material or the like (the surface facing the toner carrier roller 2) is covered by the insulation layer 5 made of an insulation material. By this configuration, the charge injection to the toners by the direct contact of the electrode 42 and the conductive surface and leakage of the charge of the toners to the electric layer can be avoided.

As the electrode 42, an electrode having a length in the direction orthogonal to the roller rotation direction in the surface facing the toner carrier roller 2 to be a length in the same direction as the surface facing the electrode 42 in the toner carrier roller 2 or more is used. By this configuration, the separation process of the oppositely-charged toners and the highly-charged toners can be conducted on the toners hopping in the carrying area Ar1 over the entire area in the orthogonal direction.

Moreover, as the electrode 42, an electrode having a length in the roller rotation direction in the surface facing the toner carrier roller 2 to be a length of the development area Ar2 in the roller rotation direction or more is used. By this configuration, different from the case in which the length is shorter than the length of the development area Ar2 in the roller rotation direction, the toners are carried for a longer time than the development area passing time just below the electrode 42, so that the oppositely-charged toners and the highly-charged toners which cause the scumming in the development area Ar2 can be effectively separated.

A toner hopping condition in the area (hereinafter referred to as a collection area before development) where the toner carrier roller 2 faces the electrode 42 in the area Ar1 is set to be same as the toner hopping condition in the development area Ar2. By this configuration, the deterioration in the separation and collection accuracy of the oppositely-charged toners and the highly-charged toners resulting from the toner hopping condition in the collection area different from the development area Ar2 can be avoided. In addition, the toner hopping condition in this case is a combination of the width of the electrodes (3a, 3b), the pitches of the electrodes, the property of the pulse voltage to be applied to each electrode, and the thickness of the surface layer (5).

### Embodiment 7

Next, a modified example (Embodiment 7) of the outside electrode 4a will be described.

In the conventional technique, the width of the outside electrode 4a (the length in the toner carrier roller surface movement direction) and the width of the inside electrode facing portion (the portion where the inside electrode 3a which does not face the outside electrode 4a faces) are set according to the strength of the electric field for the flare, such that most of the toners on each outside electrode 4a can move to any of the portions between the two outside electrodes adjacent to each outside electrode 4a, and most of the toners on the inside electrode facing portion can move to any of the two outside electrodes adjacent to each inside electrode facing portion.

In this case, if the width of the outside electrode 4a and the width of the inside electrode facing portion are equal (technically, including some unevenness by manufacturing errors) and the inside electrode 3a and the outside electrode 4a are the equal electric potential, the electric field for the flare having a small amount of unevenness on the toner carrier roller 2 can be formed. In this case, the toners on the toner carrier roller 2 can hop in a state in which the toners are equally dispersed over the entire area of the outer circumferential surface to which the inside electrode 3a and the outside electrode 4a face as long as another external force acts on the toners hopping on the toner carrier roller 2.

However, if the inside electrode 3a and the outside electrode 4a are not equal electric potential, and the electric potential gradient by the magnification errors occurs in the surface movement direction of the toner carrier roller 2 in the electrodes 3a, 4a, the electric field for the flare may be formed in the surface movement direction of the toner carrier roller 2. In this case, the toners hopping on the toner carrier roller 2 move in the surface movement direction of the toner carrier roller 2 while hopping in the outside electrode 4a and the inside electrode facing portion according to the electric potential gradient. As a result, the toners are eccentrically-located, and large unevenness of the toner amount (unevenness of low frequency) occurs on the toner carrier roller 2.

There may be a case in which an external force which moves the toners on the upstream side or the downstream side of the toner carrier roller 2 in the surface movement direction is generated by the effect of air current generated near the surface of the toner carrier roller 2 on the toners. If the external force is generated on the downstream side of the toner carrier roller 2 in the surface movement direction, for example, a lot of toners hopping on the toner carrier roller 2 move on the downstream side of the tore carrier roller 2 in the surface movement direction in the hopping by the effect of the electric field for the flare and the external force. For this reason, a lot of toners move in the surface movement direction of the toner carrier roller 2 while hopping on the outside electrode 4a and the inside electrode facing portion to move on the downstream side of the toner carrier roller in the surface movement direction. As a result, the toners are eccentrically-located on the toner carrier roller 2, and large unevenness of the toner amount (unevenness of low frequency) is generated on the toner carrier roller 2.

The above unevenness causes image concentration unevenness.

FIG. 20 is a view schematically illustrating a cross-section of the toner carrier roller 2 in Embodiment 7 cut along the plane orthogonal to the rotation axis.

FIG. 21 is a view illustrating power source lines.

In Embodiment 7, the widths of the outside electrodes 4a are manufactured to be equal, but the widths of the inside electrode facing portions are manufactured such that a short width Y1 and a long width Y2 in the surface movement direction of the toner carrier roller 2 are alternately provided. The difference of the short width Y1 and the long width Y2 (Y2−Y1) is a difference over the manufacturing error range when equally manufacturing the width of the inside electrode facing portion. By this configuration, even if the external force which moves the toners on the upstream side or the downstream side of the toner carrier roller in the surface movement direction occurs by the potential gradient or the air current, the eccentric location of the toners on the toner carrier roller 2 can be controlled as described below.

Upon the generation of such an external force, a lot of toners hopping on the toner carrier roller 2 move in the surface movement direction of the toner carrier roller according to the direction of the force. In this case, as illustrated in FIG. 21, the strength of each electric field for the flare (the electric field formed outside the surface layer 6) formed between the two inside electrode facing portions adjacent to one outside electrode 4a relatively changes according to the width of the inside electrode facing portion. Namely, the electric field for the flare formed between the inside electrode facing portions of long width Y2 becomes stronger than the electric field for the flare formed between the inside electrode facing portions of the short width Y1. The electric field for the flare formed between the inside electrode facing portions of the long width Y2 becomes a strong electric field compared to the case when the widths of the inside electrode facing portions are equal if the voltage to be applied to the inside electrodes 3a and the outside electrode 4a is the same. Accordingly, a lot of toners hopped to the inside electrode facing portion of the long width Y2 adjacent in the direction of the force from the outside electrode 4a can be returned again on the outside electrode 4a even if the above-described force is generated. As a result, the toners which move to the external electrode 4a adjacent to the direction of the force is reduced in the toners moved to the inside electrode facing portion of the long width Y2 adjacent to the direction of the force from the outside electrode 4a.

In Embodiment 7, the inside electrode facing portion of the long width Y2 serves as a barrier which prevents the movement of the toners in the direction of the force, so that the eccentric location of the toners on the toner carrier roller 2 can be controlled. Therefore, the generation of unevenness of the toner amount (unevenness of low frequency) on the toner carrier roller 2 can be controlled, and the image concentration unevenness can be controlled.

In Embodiment 7, since the toner amount between the inside electrode facing portion of the long width Y2 and the outside electrode 4a adjacent thereto is larger than the toner amount between the inside electrode facing portion of the short width Y1 and the outside electrode 4a adjacent thereto, the toner amount on the toner carrier roller 2 becomes uneven. However, such unevenness is high frequency unevenness having a very short cycle, so that the effect on the image concentration is less. Even if such unevenness has an effect on the image concentration, such unevenness can not be detected, so it does not substantially affect an image quality.

In Embodiment 7, it is preferable for the long width Y2 of the inside electrode facing portion to be set to 2 to 5 times the short width Y1 of the inside electrode facing portion. If it is less than 2 times, a sufficient electric field for the flare which is formed between the inside electrode facing portions of the long width Y2 can not be obtained, and it can not serve as the barrier, resulting in the decrease in the control effect of the image concentration unevenness. On the other hand, if it is above 5 times, the toners in the central portion of the inside electrode facing portions of the long width Y2 can not move on the outside electrode 4a, and it becomes difficult to effectively cloud the toners. In addition, it is preferable for the short width Y1 of the inside electrode facing portions to be the same as the electrode width of the outside electrode 4a.

In Embodiment 7, the width of the outside electrode 4a is set to 40 μm, the short width of the inside electrode facing portion Y1 is set to 40 μm and the long width Y2 of the inside electrode facing portion is set to 120 μm.

In Embodiment 7, the widths X of the outside electrodes 4a are equal and the widths of the inside electrode facing portions are unequal, but the widths X of the outside electrodes can be unequal and the widths of the inside electrode facing portions can be equal. In this case, the same effect can be obtained.

In Embodiment 7, the widths of the inside electrode facing portions are unequal such that the short width Y1 and the long width Y2 are alternately provided in the surface movement direction of the toner carrier roller 2. However, the widths of the inside electrode facing portions can be set to provide one long width Y2 after two short widths Y1. In addition, the width type can be three or more.

### EXAMPLE

Next, specific examples and comparative examples according to the above embodiments will be described.

A toner carrier roller used in the example includes an inside electrode (electrode B) made of an aluminum hollow roller member (16 mm in outer diameter and 250 mm in length), a melamine resin insulation layer and a plurality of long outside electrodes (80 μm in width) parallel to the roller axis, the plurality of outside electrodes being provided at 80 μm intervals, and both ends of the outside electrodes being electrically connected to each other by a connection portion made of a material which is the same as that of the outside electrode, the outside electrode having a smooth outer circumferential surface covered by a surface layer having a thickness of 20 μm.

Voltages different from one another are applied to the outside electrodes and the inside electrode of the toner carrier roller in the environment of 30° C. in temperature and 90% in relative humidity, and the generation of leakage is confirmed with time (corresponding to A4-size 3000000 sheets printing). Vpp of the AC component of the voltage to be applied to each electrode is 500V, and the phase is phase shifted by π to each other, a waveform is a rectangular wave, a sine wave, a triangular wave and a saw wave. The frequency of the AC component is 500 Hz.

An image formation test (the linear speed of the toner supply roller is 200 mm/sec) was performed in the conditions of the following Examples 1-9 and the comparative examples 1-6, the generation of leakage between the outside electrodes and the inside electrode was examined by measuring a resistance value with a tester (digital tester CDM-2000D manufactured by CUSTOM Co., Ltd.) in the beginning, after forming 300000 images (300 k) and after forming 3000000 images (3000 k).

### Example 1

Silver paste was used as the material of the outside electrodes, and the difference between the DC component of the outside electrodes and the AC component of the inside electrode was set to −10V. A rectangular wave (DUTY 50%) was used for the AC component applied to each of the inside electrode and the outside electrode. The thickness of the insulation layer was set to 20 μm.

The electrode using the paste was manufactured as follows. An electrode pattern of 220 mm in length and 80 μm in width was printed on the surface of the insulation layer provided on the side face of the aluminum hollow roller at 80 μm intervals with the conductive paste with a screen printing method. After that, a heating process of 150° C. was conducted.

### Example 2

Similar to Example 1, but copper paste was used as the material of the outside electrodes.

### Example 3

Similar to Example 1, but solder paste was used as the material of the outside electrodes.

### Example 4

Similar to Example 1, but a sine wave was applied to the AC component of the outside electrodes and the inside electrode.

### Example 5

Similar to Example 1, but a rectangular wave (DUTY 25%) was used for the AC component of the voltage applied to the outside electrodes and the inside electrode.

### Example 6

Similar to Example 1, but a triangular wave was applied to the AC component of the voltage applied to the outside electrodes and the inside electrode.

### Example 7

Similar to Example 1, but a saw wave was applied to the AC component of the voltage applied to the outside electrodes and the inside electrode.

### Example 8

Similar to Example 1, but the difference between the DC component of the voltage applied to the outside electrodes and the DC component of the voltage applied to the inside electrode was set to −50V.

### Example 9

Similar to Example 1, but the difference between the DC component of the voltage applied to the outside electrodes and the DC component of the voltage applied to the inside electrode was set to −100V.

### Comparative Example 1

Similar to Example 1, but the difference between the DC component of the voltage applied to the outside electrodes and the DC component of the voltage applied to the inside electrode was set to 0V.

### Comparative Example 2

Similar to Example 1, but the difference between the DC component of the voltage applied to the outside electrodes and the DC component of the voltage applied to the inside electrode was set to 0V.

### Comparative Example 3

Similar to Example 3, but the difference between the DC component of the voltage applied to the outside electrodes and the DC component of the voltage applied to the inside electrode was set to 0V.

### Comparative Example 4

Similar to Example 1, but the difference between the DC component of the voltage applied to the outside electrodes and the DC component of the voltage applied to the inside electrode was set to +10V.

### Comparative Example 5

Silver paste was used as the material of the outside electrode, and the difference between the DC component of the outside electrodes and the DC component of the inside electrode was set to 0V. A sine wave was applied to the AC component of the outside electrode and the inside electrode. The film thickness of the insulation layer was set to 20 μm.

### Comparative Example 6

Similar to Example 1, but the difference between the DC component of the voltage applied to the outside electrodes and the DC component of the voltage applied to the inside electrode was set to 0V. The film thickness of the insulation layer was set to 40 μm.

The results of the above Examples and the Comparative examples are illustrated in the following Table 1. They are evaluated as x when leakage occurs and as o when leakage does not occur.

TABLE 1

| | CONDITION | | | | | | | |
|---|---|---|---|---|---|---|---|---|
| | ELECTRODE | | DC COMPONENT | | INSULATION | | | |
| | MATERIAL | | DIFFERENCE | WAVEFORM | LAYER FILM | RESULT | | |
| | OUTSIDE | INSIDE | OF VOLTAGE | (Duty %) | THICKNESS | BEGINNING | 300k | 3000k |
| EXAMPLE 1 | SILVER | ALUMINUM | −10 | RECTANGLE | 20 μm | ∘ | ∘ | ∘ |
| | | | | (50) | | | | |
| EXAMPLE 2 | COPPER | | −10 | RECTANGLE | 20 μm | ∘ | ∘ | ∘ |
| | | | | (50) | | | | |
| EXAMPLE 3 | SOLDER | | −10 | RECTANGLE | 20 μm | ∘ | ∘ | ∘ |
| | | | | (50) | | | | |
| EXAMPLE 4 | SILVER | | −10 | SINE | 20 μm | ∘ | ∘ | ∘ |
| EXAMPLE 5 | SILVER | | −10 | RECTANGLE | 20 μm | ∘ | ∘ | ∘ |
| | | | | (25) | | | | |
| EXAMPLE 6 | SILVER | | −10 | TRIANGLE | 20 μm | ∘ | ∘ | ∘ |
| EXAMPLE 7 | SILVER | | −10 | SAW | 20 μm | ∘ | ∘ | ∘ |
| EXAMPLE 8 | SILVER | | −50 | RECTANGLE | 20 μm | ∘ | ∘ | ∘ |
| | | | | (50) | | | | |
| EXAMPLE 9 | SILVER | | −100 | RECTANGLE | 20 μm | ∘ | ∘ | ∘ |
| | | | | (50) | | | | |
| COMPARATIVE | SILVER | | 0 | RECTANGLE | 20 μm | ∘ | ∘ | x |
| EXAMPLE 1 | | | | (50) | | | | |
| COMPARATIVE | COPPER | | 0 | RECTANGLE | 20 μm | ∘ | ∘ | x |
| EXAMPLE 2 | | | | (50) | | | | |
| COMPARATIVE | SOLDER | | 0 | RECTANGLE | 20 μm | ∘ | ∘ | x |
| EXAMPLE 3 | | | | (50) | | | | |
| COMPARATIVE | SILVER | | 10 | RECTANGLE | 20 μm | ∘ | x | x |
| EXAMPLE 4 | | | | (50) | | | | |
| COMPARATIVE | SILVER | | 0 | SINE | 20 μm | ∘ | ∘ | x |
| EXAMPLE 5 | | | | | | | | |
| COMPARATIVE | SILVER | | 0 | RECTANGLE | 40 μm | ∘ | ∘ | x |
| EXAMPLE 6 | | | | (50) | | | | |

According to Table 1, it was confirmed that the condition in which the difference between the DC component of the voltage applied to the outside electrodes and the DC component of the voltage applied to the inside electrode is negative, leakage does not occur over a long period of time.

According to the development device of the above embodiments, the DC component of the voltage to be applied to the inside electrode and the outside electrode is made of different voltages from one another, so that the ion migration can be prevented in advance even if silver, copper, lead, tin or an ally of these is used as the electrode. Thus, a long-lived development device can be provided, and an image can be stably formed over a long period of time.

Moreover, according to the development device of the above embodiments, the inside electrode is provided in the planar shape over the entire toner carrying face in the second predetermined depth position. Therefore, the toner carrier can be easily manufactured.

Furthermore, according to the development device of the above embodiments, since the outside electrode is made of silver, copper, lead, tine or alloy of these, the toner carrier roller can be easily produced.

Further, according to the development device of the above embodiment, since the voltage of the DC component in the voltage to be applied to the outside electrode is maintained lower than the voltage of the DC component in the voltage to be applied to the inside electrode, the ion migration can be effectively prevented by using the electrode member for use in a general electrode.

Although the embodiments of the present invention have been described above, the present invention is not limited thereto. It should be appreciated that variations may be made in the embodiments described by persons skilled in the art without departing from the scope of the present invention.

What is claimed is:

1. A development device, comprising:
a toner carrier, including:
a plurality of long outside electrodes provided at intervals in a first predetermined depth position from a toner carrying surface, and a longitudinal direction of each outside electrode crossing a toner carrying direction:
an inside electrode provided at least in a portion between the long outside electrodes in a second predetermined depth position deeper than the first predetermined depth; and
an insulation layer between a layer having the outside electrodes and a layer having the inside electrode; and
a voltage applier configured to apply a voltage which hops toners on the toner carrying surface to the inside electrode and the outside electrodes,
the voltage applier configured to apply a voltage made of a DC component and an AC component having a phase opposite to each other to both of the inside electrode and the outside electrodes, or to apply a voltage made of the AC component and the DC component to one of the inside electrode and the outside electrodes and the voltage made of the DC component to the other electrode, and
a value of the DC component of the voltage to be applied to each of the inside electrode and the outside electrode being different from one another.

2. The development device according to claim 1, wherein the inside electrode has a planar shape provided in the second predetermined depth position over the entire toner carrying surface.

3. The development device according to claim 1, wherein the outside electrode is made of silver, copper, lead, tin or an alloy of these.

4. The development device according to claim 2, wherein the outside electrode is made of silver, copper, lead, tin or an alloy of these.

5. The development device according to claim 3, wherein the voltage of the DC component in the voltage to be applied to the outside electrode is maintained lower than the voltage of the DC component in the voltage to be applied to the inside electrode.

6. The development device according to claim 4, wherein the voltage of the DC component in the voltage to be applied to the outside electrode is maintained lower than the voltage of the DC component in the voltage to be applied to the inside electrode.

7. A process cartridge comprising the development device according to claim 1.

8. An image forming apparatus comprising the process cartridge according to claim 7.
